(19) United States
(12) Patent Application Publication
(10) Pub. No.: US 2026/0032086 A1
(43) Pub. Date: Jan. 29, 2026

(54) METHOD, SYSTEM, AND COMPUTER PROGRAM PRODUCT FOR ADDRESS TRANSLATION

(71) Applicant: DELL PRODUCTS L.P., ROUND ROCK, TX (US)

(72) Inventors: Yubing Zhang, Shanghai (CN); Yongsheng Guo, Shanghai (CN); Jing Yu, Shanghai (CN); Cherami Liu, Shanghai (CN); Ruyao Zhang, Yangpu (CN); Meng Zhou, Shanghai (CN)

(21) Appl. No.: 18/905,334

(22) Filed: Oct. 3, 2024

(30) Foreign Application Priority Data
Jul. 26, 2024 (CN) 202411017640.3

(51) Int. Cl. H04L 47/125; H04L 45/74; H04L 47/2416

(52) U.S. Cl. CPC H04L 47/125; H04L 45/74; H04L 47/2416

(57) ABSTRACT

The present disclosure relates to a method, system, and computer program product for address translation. The method includes receiving an access request from the outside of a cluster service to the inside by an ingress control service. The method further includes generating a callback for the access request in response to receiving the access request. The method further includes translating a source address of the callback to a network address of the ingress control service by an egress container group, wherein the network address of the ingress control service is a destination address of the access request. According to embodiments of the present disclosure, by this method of translating the source address of the callback to the destination address of the access request, it is possible to enhance the security of network communication and improve the convenience of network management, which enhances the management experience of a network administrator.

### TECHNICAL FIELD

The present disclosure generally relates to the field of computers and, more particularly, to a method, system, and product for address translation.

### BACKGROUND

In today's highly digitized world, managing network ingress and egress traffic is the cornerstone for building a stable, efficient, and secure network environment. By regulating network boundaries, cluster services such as container orchestration systems like Kubernetes are capable of defending against potential network security threats such as malware and a variety of attacks, and at the same time, they can also enhance the performance of the network. For example, bandwidth resources can be intelligently allocated with the help of ingress gateways and egress gateways.

An ingress gateway is a component in a service mesh (e.g., Istio) that is used to manage the traffic entering the mesh. Similar to a load balancer or reverse proxy in a conventional network, it can receive requests from external protocols such as HTTP, HTTPS, and TCP, and route these requests to corresponding services within the mesh according to the configured rules. Corresponding to the ingress gateway, an egress gateway is a component in a service mesh that is used to manage traffic leaving the mesh. With the egress gateway, the service mesh can perform monitoring, routing, and security control on the outbound traffic. Ingress and egress gateways can be used not only for service meshes, but also in cluster services to achieve similar functionality by means of customized ingress controllers or network policies, which enable an administrator to better control network traffic, thus simplifying the design and operation and maintenance of the network architecture.

### SUMMARY OF THE INVENTION

Embodiments of the present disclosure propose a method, system, and computer program product for address translation.

In a first aspect of embodiments of the present disclosure, a method for address translation is provided. The method includes receiving an access request from the outside of a cluster service to the inside by an ingress control service. The method further includes generating a callback for the access request in response to receiving the access request. The method further includes translating a source address of the callback to a network address of the ingress control service by an egress container group, wherein the network address of the ingress control service is a destination address of the access request.

In a second aspect of embodiments of the present disclosure, a system for providing a cluster service is provided. The system includes one or more processors; and a storage apparatus for storing one or more programs, wherein the one or more programs, when executed by the one or more processors, cause the one or more processors to implement a method for address translation, the method including receiving an access request from the outside of a cluster service to the inside by an ingress control service. The method further includes generating a callback for the access request in response to receiving the access request. The method further includes translating a source address of the callback to a network address of the ingress control service by an egress container group, wherein the network address of the ingress control service is a destination address of the access request.

In a third aspect of embodiments of the present disclosure, a computer-readable storage medium is provided, which has a computer program stored thereon, wherein the program, when executed by a processor, implements a method for address translation, the method including generating, in response to receiving an access request from the outside of a cluster service to the inside by an ingress controller, a callback for the access request. The method further includes translating a source address of the callback to a network address of the ingress controller by an egress container group, wherein the network address of the ingress controller is a destination address of the access request.

It should be understood that the content described in the Summary of the Invention part is neither intended to limit key or essential features of the embodiments of the present disclosure, nor intended to limit the scope of the present disclosure. Other features of the present disclosure will become readily understood from the following descriptions.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which a plurality of embodiments of the present disclosure can be implemented;

FIG. 2 illustrates a flow chart of a method for address translation according to some embodiments of the present disclosure;

FIG. 3 illustrates a schematic diagram of address translation at a data link layer of a single-level network according to some embodiments of the present disclosure;

FIG. 4 illustrates a schematic diagram of the effect of address translation at a data link layer of a single-level network according to some embodiments of the present disclosure;

FIG. 5 illustrates a schematic diagram of address translation at a network layer of a single-level network according to some embodiments of the present disclosure;

FIG. 6 illustrates a schematic diagram of address translation at a network layer of a multi-level network according to some embodiments of the present disclosure;

FIG. 7 illustrates a schematic diagram of address translation at a data link layer of a multi-level network according to some embodiments of the present disclosure; and

FIG. 8 illustrates a block diagram of a system that can implement a plurality of embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be interpreted as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

As discussed above, managing network ingress and egress traffic is the cornerstone for building a stable, efficient, and secure network environment. In order to ensure the security of a cluster service, it is usually required that the ingress destination network address at which an external proxy accesses the cluster service is consistent with the address at which the cluster service performs callback to the external proxy, which can facilitate identity authentication of the external proxy and thus ensure the security of the established dialogue. In one related technique, the cluster service can be configured as a micro-service based on Network Address Translation (NAT), in which case the address of the gateway of the application network interface (API) is the address of the internal gateway, which enables secure authentication of external proxies, thus ensuring secure access. However, while this NAT-based micro-service architecture hides the address of the internal network to a certain extent, it increases the complexity of the network and also limits the scalability of the service, and the NAT-based architecture is not the best choice for cloud-native technologies, is difficult to integrate with modern cloud-native ecologies, and thus lacks flexibility.

In another related technique, the cluster service employs a cloud-native network architecture to overcome the limitations of the framework based on NAT micro-services, but still fails to guarantee the consistency of ingress and egress addresses, thus limiting the identity authentication of external proxies. Take a container cluster service that employs Kubernetes as an example, and assume that there are multiple nodes in a cluster. Looking from the ingress direction, an external proxy accesses the cluster service through the network address of the ingress gateway or ingress controller, and then, the request will be routed to a container group (Pod) configured on a back-end node. Looking from the egress direction, a container group inside the cluster service will initiate a callback to the external proxy over the network. If source network address translation (SNAT) is enabled at the network interface of the host/node, the source address of the callback data packet will be marked as the address of the host/node. If source network address translation is not enabled, the source address of the callback data packet will be the address of the container group. In any case, the address of the ingress gateway or ingress controller that the external proxy requests to access and the source address at which the cluster service performs a callback to the external proxy are not unified, which restricts the security checking of the cluster service by the external proxy, thus affecting network communication and decreasing the efficiency of the service.

Another related technique is to establish an outbound IP pool for an external proxy, and the addresses in this outbound IP pool are all on the whitelist of the external proxy to support security authentication. However, this scheme does not take into account the fact that containerized applications are transitory and containers can be started and stopped quickly, which means that the network address associated with a container changes frequently, thus making it difficult for an external proxy to track the source address of a valid callback.

To this end, on the basis of such cloud-native cluster service with flexibility and scalability, embodiments of the present disclosure propose a scheme for address translation. Specifically, when an ingress controller receives an access request from the outside of a cluster service to the inside, a callback for that request may be generated within the cluster. At the same time, in order to ensure that the callback can be properly returned to the initiator that initiated the access request, the source address of the callback can be translated to the network address of the ingress controller by the egress container group, where the network address of the ingress controller is the destination address of the original access request.

By means of this address translation, it is possible to ensure that the callback is properly returned to the external initiator that initiated the access request, while maintaining the security and isolation of the internal network of the cluster. This enables cluster services to respond to external access requests in a more flexible and secure manner.

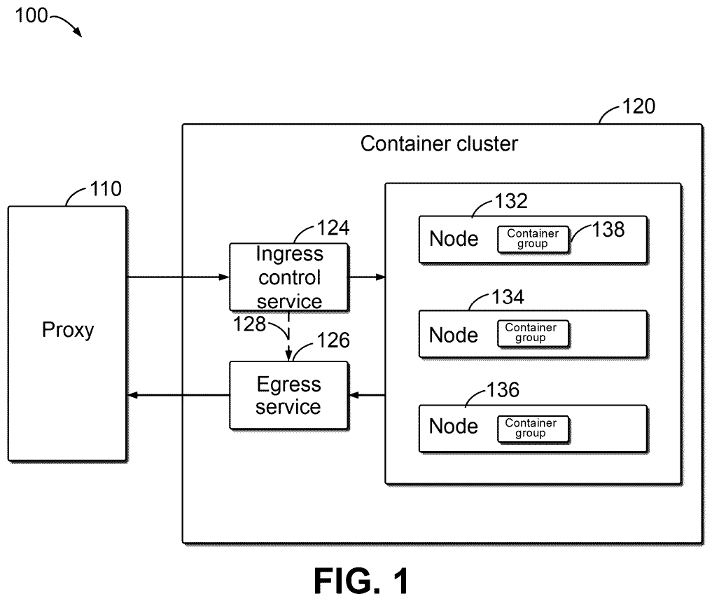

FIG. 1 illustrates a schematic diagram of an example environment 100 in which a plurality of embodiments of the present disclosure can be implemented. In cloud computing and micro-service architectures, container orchestration (e.g., Kubernetes) technologies are widely used for deployment, management, and scaling of applications. As shown in FIG. 1, a container cluster 120 is a container cluster that is constructed by applying the container orchestration technology, the container cluster being composed of a plurality of nodes (e.g., a node 132, a node 134, a node 136, and so on), thus making it possible to enhance the availability and scalability of external services. There may be one or more container groups configured on each node. For example, a container group 138 may be run on the node 132 to perform a specific task. These container groups are organized into services according to a certain logic, and these container groups can communicate with each other through an internal network, while the container cluster service can also provide an interface to the outside.

Referring to FIG. 1, in order to enable an external proxy 110 to access a service within the container cluster 120, the container cluster 120 is typically configured with an ingress controller service, and a network address is exposed to the outside by an ingress controller in the ingress control service 124. This ingress controller can be commonly considered to be the ingress gateway of the container cluster 120. The external proxy 110 may access the container cluster service 120 via the network address exposed by the ingress controller in the ingress control service 124 so as to meet its business needs. The external proxy 110 may be any device or software capable of initiating network requests for use in interaction with the container cluster 120. The external proxy may, for example, be a diversity of clients such as a personal computer (PC), a mobile device, an Internet of Things (IoT) device, an embedded system, or an API client library. In a container cluster, the ingress controller can be varied, which specifically depends on the specific requirements of the service provided by the container cluster.

As shown in FIG. 1, when the container cluster 120 receives a request from the external proxy 110 and initiates a callback, the source address of the callback data packet can be translated, with the aid of an egress service 126 by means of 128, to the network address of the ingress controller in the ingress control service 124 instead of the address of the node in the container cluster or the address of the container group. Specifically, in some embodiments, an egress container group may be configured in the egress service 126 of the container cluster 120 to manage and control the outbound traffic from the inside of the cluster service to the outside. In some embodiments, the egress container group and the ingress controller may also be configured in the same network, and then the source address of the outbound traffic is replaced with the network address that is exposed to the outside by this ingress controller. It can be understood that this egress container group can be considered commonly as the egress gateway of the container cluster 120. The outbound traffic described herein may be a flow of information for a request from the outside of the cluster to the inside, and the outbound traffic may be a flow of information for a callback from the outside of the cluster to the inside.

In this way, when the external proxy 110 receives the callback, it can conveniently verify the source of the callback data packet, that is, it can confirm that the callback data packet really comes from the container cluster service 120 when knowing the ingress network address of the container cluster 120. This not only simplifies the process of identity authentication, but also improves the security of communication so that the container cluster 120 is enabled to effectively interact with the external proxy 110, while also ensuring the security and credibility of data transmission.

It can be understood that in the context of container clusters, nodes typically refer to physical or virtual machines, and these nodes can also be referred to as servers, which can be bare-metal servers, for example. It can be understood that in the present disclosure, the network address of the ingress controller or the address exposed to the outside by the ingress controller may be expressed as the ingress network address, and may also be expressed as a destination address accessible to the external proxy. The source address of the callback may be expressed as the source address of the callback data packet and may also be expressed as the source address of the outbound traffic. It can be understood that all the addresses described here can be IP addresses. It can be understood that in container cluster services, the functionality of the ingress gateway is realized by configuring ingress resources. The ingress service requires an ingress controller to implement these rules. The ingress gateway is typically an instance of the ingress controller, which is a specific network component that is responsible for implementing the routing rules defined by the ingress. Similarly, the egress gateway is an instance of an egress service.

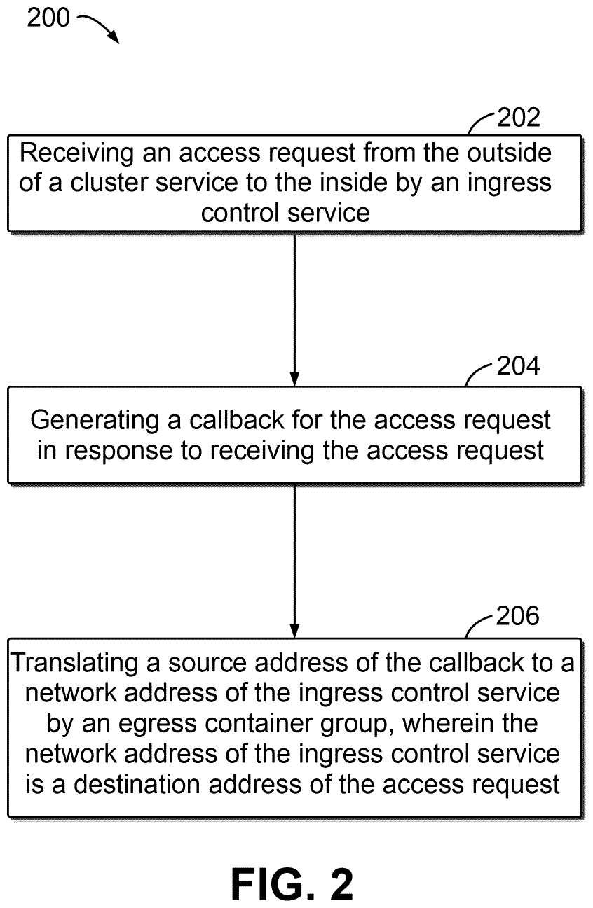

FIG. 2 illustrates a flow chart of a method 200 for address translation according to some embodiments of the present disclosure. Referring to FIG. 2, the method 200 includes a block 202, a block 204, and a block 206. The execution subject of the method 200 may be an apparatus for address translation, which may be a server, for example, a computing system, a single server, and a distributed server, or a system of servers configured in a cloud, or a stand-alone apparatus or system. The apparatus can be realized by means of software and/or hardware. The method 200 will be described below with the execution subject being an apparatus for address translation.

At block 202, an access request from the outside of a cluster service to the inside is received by an ingress control service. Referring to FIG. 1, in some embodiments, when an external client or external proxy 110 initiates an access request to a cluster service such as the container cluster 120 shown in FIG. 1, the access request may be forwarded by the ingress control service 124 to a back-end entity of the cluster service that is associated with the access request. For example, it may be forwarded to the container group 138 that performs the tasks associated with the access request. The ingress control service 124 here may be an instance of an ingress controller, i.e., an ingress gateway.

At block 204, a callback for the access request is generated in response to receiving the access request. Upon receiving an access request, the cluster service 120 generates a callback. In some embodiments, this callback is a specific function or method that will be called during subsequent processing to perform operations related to the access request. The callback is generated as a response from the cluster service 120 to the access request. In this way, when further processing of or response to the access request is required, the callback can be called to perform the corresponding operations.

At block 206, a source address of the callback is translated to a network address of the ingress control service by an egress container group, wherein the network address of the ingress control service is a destination address of the access request. Referring to FIG. 1, in order to enable the external proxy 110 or client to conveniently identify the source address of the callback, the source address of the callback may be translated to a network address exposed to the outside by the ingress controller by means of the egress service 126 (on which the egress container group is dispatched). The network address exposed to the outside by the ingress controller is the destination address requested by the external client or external proxy 110 for access. In this way, the external proxy or client is enabled to conveniently perform identity authentication, thus ensuring the security of network communication.

By this method of translating the source address of the callback to the destination address of the access request, it is not only possible to enhance the security of network communication, but also possible to improve the convenience of network management, which enhances the management experience of a network administrator.

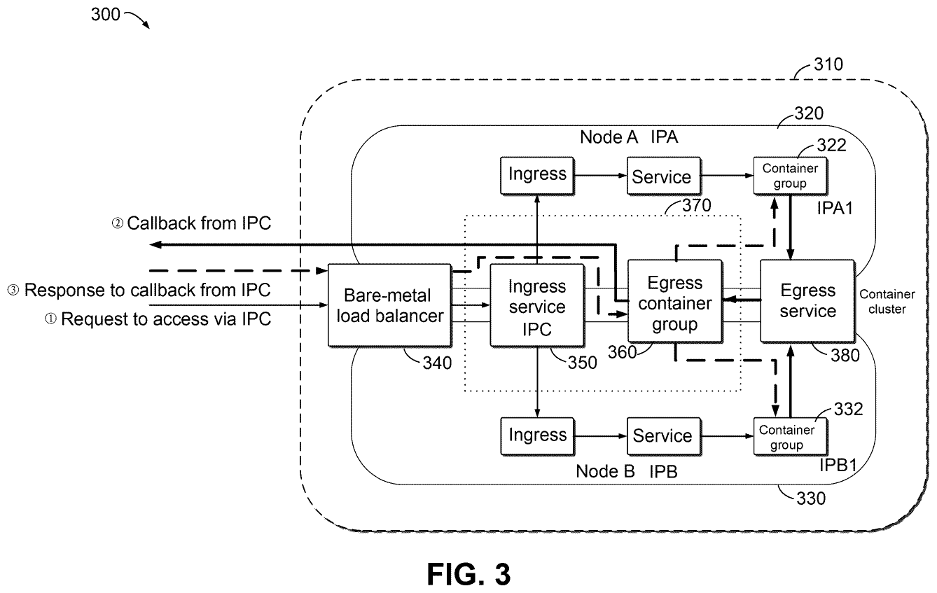

The description will be given below in conjunction with FIG. 3. FIG. 3 illustrates a schematic diagram of address translation 300 at a data link layer of a single-level network according to some embodiments of the present disclosure. The nodes in a container cluster 310 shown in FIG. 3 are all at the same single-level network. As shown in FIG. 3, a node A 320, a node B 330, and the like are configured in the container cluster 310, and these nodes work collectively to provide highly available and scalable services. In some embodiments, these nodes may be built with bare-metal servers. The nodes A and B are respectively configured with a container group 322 and a container group 332 to run service instances. It can be understood that there may be a plurality of nodes configured in a container cluster, and one or more container groups may be configured on each node, where each container group consists of containers.

Referring to FIG. 3, in order to further improve the availability, scalability, and performance of the container cluster service, the container cluster 310 is also configured with a bare-metal load balancer 340, which is different from a software-defined load balancer or a load balancer in a cloud service, but is a load balancing solution that runs on physical hardware. The bare-metal load balancer 340 supports two main operation modes: L2 (data link layer) mode and L3 (network layer) mode. In the L2 mode, the bare-metal load balancer 340 uses techniques of the link layer (i.e., the data link layer, which is the second layer of the OSI model) to achieve load balancing. The L3 mode, on the other hand, uses techniques of the network layer (the third layer of the OSI model), which mainly achieves load balancing by means of a border gateway protocol (BGP) or static routing.

Referring to FIG. 3, in order to facilitate access to the services within the container cluster 310 by external proxies or clients, an ingress service 350 may be configured within the container cluster 310 to define how external HTTP and HTTPS traffic is routed to services within the container cluster 310. Rules can be configured for ingress resources, such as directing traffic to specific services based on conditions such as URL paths, host names, and so on, which is not limited in the present disclosure. It can be understood that the ingress service itself does not have any actual network functions, and it needs an ingress controller to implement these rules. The ingress gateway is an instance of the ingress controller, which is a specific network component that is responsible for implementing the routing rules defined by the ingress resources. The ingress gateway can be a reverse proxy like Nginx, Traefik, and HAProxy or load balancer software, or a component in a service mesh. The ingress gateway not only provides basic routing functionality, but also can add additional features such as SSL/TLS termination, identity authentication, flow limiting, and log records. Similarly, the egress gateway is an instance of an egress service.

With continued reference to FIG. 3, the external proxy may access the container cluster via the network address IP C that is exposed to the outside of the container cluster by the ingress service 350, thereby allowing requests sent by the external proxy to be routed to a container group on a back-end node that runs the service. Afterwards, when the container group sends a callback request with respect to the request from the external proxy, the source address of the callback request can be modified from IP A1, the address of the container group 322, to IP A, the address of the node A (which is, for example, 10.10.10.10), if source network address translation is enabled on the container cluster 310. Similarly, the source address of the callback request can be modified from IP B1, the address of the container group 332, to IP B, the address of the node B (which can be, for example, 10.10.10.20). At this point, the address of the callback request identified by the external proxy is not consistent with the address it requests to access, which will affect the authentication of the callback request by the external proxy, thus affecting the efficiency of interaction. If source network address translation is not enabled on the container cluster 310, the source address of the callback request will be the private address of each container group, i.e., it might be IP A1 or IP B1. At this point, the address of the callback request identified by the external proxy is still not consistent with the address it requests to access, which still affects security authentication.

To this end, the present disclosure creatively proposes binding the egress container group and the ingress service to the same node in a single-level network in order to translate the source address of the callback to a network address exposed to the outside by the ingress service. As shown in FIG. 3, an egress container group 360 may be dispatched inside the container cluster 310 to manage and control traffic that is called back from the inside of the container cluster to the outside. The egress container group 360 is a special container group used to process callback traffic and can be created by a network plugin. The source address of the callback traffic (taking the container group 322 as an example, the source address of the callback request it sends out is the private address IP A1 of the container group 322, and the address of the node A where the container group 322 is located is IP A) can be modified to the address IP C of the ingress gateway by means of the source network address translation. This step is performed at the network edge, usually at the network interface of the node. At this point, the data packet for the callback request may start from the container group 322, pass through the egress service 380, then reach the egress container group 360, and finally reach the external proxy.

With continued reference to FIG. 3, after the source address has been translated, it is also necessary to ensure that the response packet of the external proxy for the callback can be correctly transmitted back. Since the data packet of the callback now appears to be sent out from IP C, the response packet may attempt to return to IP C rather than to the original IP A from which it was sent. To this end, this embodiment proposes to bind the egress container group 360 and the ingress service 350 to the same node 370. Thus, when the response packet reaches the bare-metal load balancer 340, the bare-metal load balancer 340 can route the response packet directly back to the egress container group 360 on the same node, thus completing the communication cycle. It can be understood that in this scenario, the bare-metal load balancer 340 has already configured the external address IP C that the ingress service 350 exposes to the outside, which enables it to advertise and receive traffic at the node level. In some embodiments, data packets can also be enabled to be routed from the egress container group 360 back to the correct container group by highly automated container orchestration techniques that use labels and selectors for matching or the like, which will not be further described in the present disclosure.

This method of dispatching the egress container group to manage the internal callback traffic enables the external proxy to effectively identify the callback request for the data packet, and this method of further binding the egress container group and the ingress service controller (or ingress gateway) to the same node also enables the response packet for the callback to be correctly routed to the corresponding node. This approach not only makes it easy to verify the network security, but also improves the efficiency of interaction, thus enhancing the user experience.

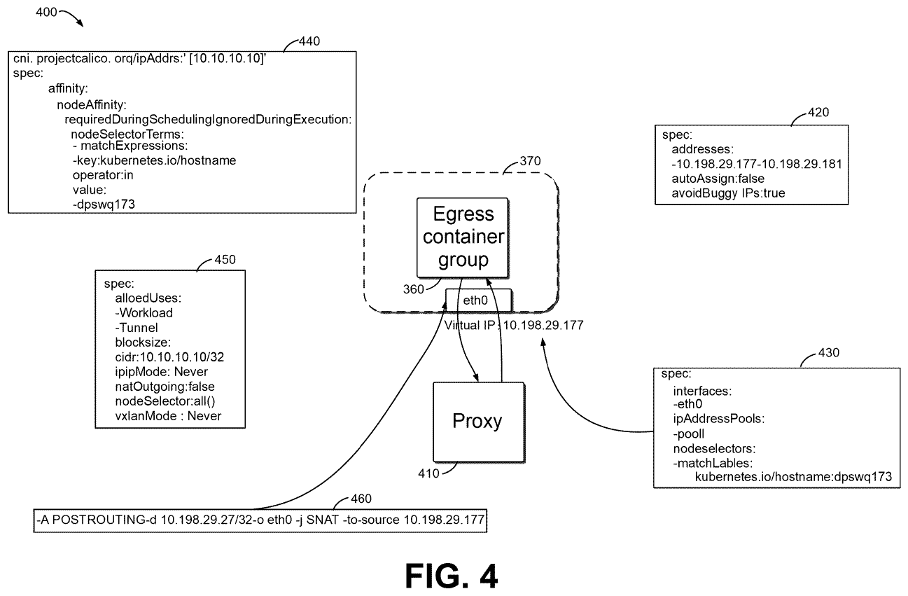

FIG. 4 illustrates a schematic diagram of the effect 400 of address translation at a data link layer of a single-level network according to some embodiments of the present disclosure. With reference to FIG. 4, as can be seen from regions 420 and 430, the bare-metal load balancer in the container cluster is at an L2 layer, which specifies that the network interface 460 participating in L2 broadcasting is eth0. The bare-metal load balancer also defines an IP address pool pooll with addresses ranging from 10.198.29.177 to 10.198.29.181, and the bare-metal load balancer does not automatically allocate IP addresses and only the node with the host name of dpswq173, i.e., a node 370, can apply this configuration.

With continued reference to FIG. 4, as can be seen in a region 440, the IP address of the egress container group 360 is 10.10.10.10, and that egress container group must be dispatched to the node labeled with the host name of dpswq173. The network policy configured for the container cluster can be seen in a region 450, including a single address 10.10.10.10 having been allocated, allowing the use of the workload and tunnel modes, prohibiting the use of outbound NAT, and so on.

As shown in FIG. 4, the external proxy 410 requests access through the network interface eth0 of the node 370, and the IP address of the access is 10.198.29.177. Next, the request can be routed to a service within the cluster, and the service within the cluster processes this request and prepares a response, which needs to be called back to the client. To facilitate identification by the proxy 410, the private address within the cluster can be translated to 10.198.29.177 through source network address translation. For example, as can be seen in the region 460, the source address 10.198.29.27/32 is translated to 10.198.29.177, thereby improving the convenience of verification of the communication security by the external proxy.

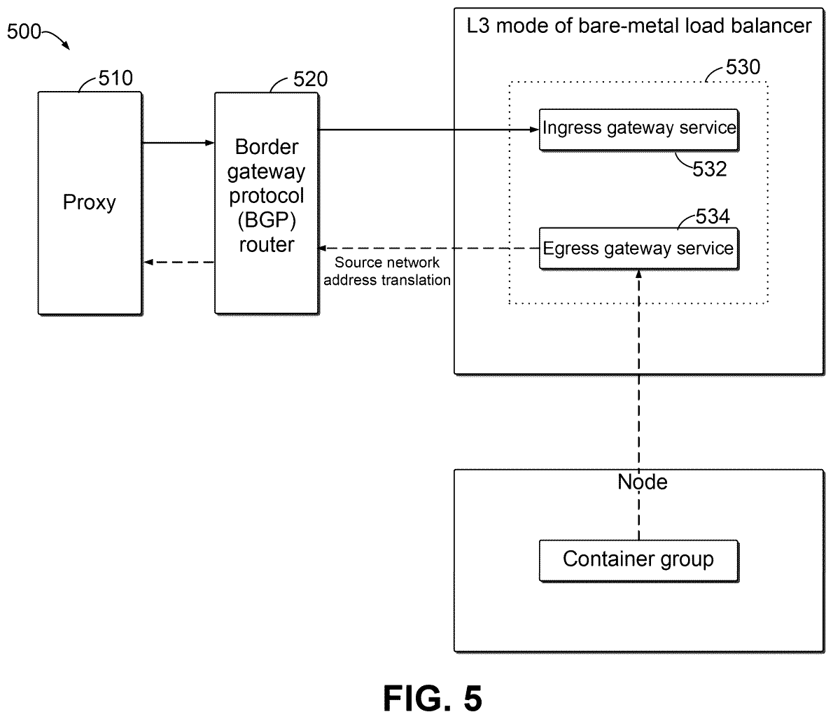

FIG. 5 illustrates a schematic diagram of address translation 500 at a network layer of a single-level network according to some embodiments of the present disclosure. With reference to FIG. 5, in this network layer mode of the single-level network, except for the difference in the working mode of the bare-metal load balancer, all the other configurations are consistent with those of the data link layer of the single-level network shown in FIG. 3, and the ingress gateway service 532 and the egress gateway service 534 (which is equivalent to the egress container group mentioned above) are also configured on the same node 530, which can ensure that the response packet from the external proxy is returned to the correct node. An instance of the egress gateway service 534 is the egress gateway, which can be considered as the egress container group in the present disclosure.

As shown in FIG. 5, the bare-metal load balancer in the container cluster is configured to be in the network layer (L3) mode, which mainly implements load balancing through the border gateway protocol (BGP) or static routing. The bare-metal load balancer will advertise the external address of the container cluster service to the router 520 outside the container cluster through the border gateway protocol (BGP). In other words, the bare-metal load balancer will advertise the address of the ingress gateway service 532 to all nodes in the single-level network where the container cluster is located through the BGP. This means that the external proxy 510 can know the addresses of all nodes running services inside the container cluster.

With continued reference to FIG. 5, in order to avoid routing the access request initiated by the external proxy 510 to a node that is not running a service, the externalTrafficPolicy in the definition of the container cluster service can be set to Local, which can ensure that the access request is only load-balanced to the node hosting the service. At the host level, it is feasible to continue to set source network address translation. In this way, the source address of the callback data packet can be translated to the external address of the ingress gateway. When the container group initiates a callback to the outside, the callback can be forwarded to an external client or proxy through the egress gateway service 534, so that the source address seen by the external proxy is the network address exposed by the ingress gateway service to the outside, thereby improving the convenience of verification of communication security by the external proxy.

In conjunction with FIGS. 3 and 5, in order to ensure that the egress container group is in an available state, a specialized monitoring service can be deployed to continuously monitor the state of all nodes, including the node configured with the egress container group. When the node changes to a down state, the monitoring service can re-dispatch the container group and the related service to a new node. In some embodiments, a plurality of egress gateway instances can also be deployed within each egress service, and these instances can all be deployed on the same node, which can help to distribute the load and alleviate the bottleneck of the container cluster service, thereby meeting the scalability requirements of the container cluster service. In some embodiments, replicas of the egress service can also be deployed on a plurality of nodes, so that even if one of the nodes fails, the services on the other nodes can still be in a serviceable state, thus ensuring high availability of the container cluster service.

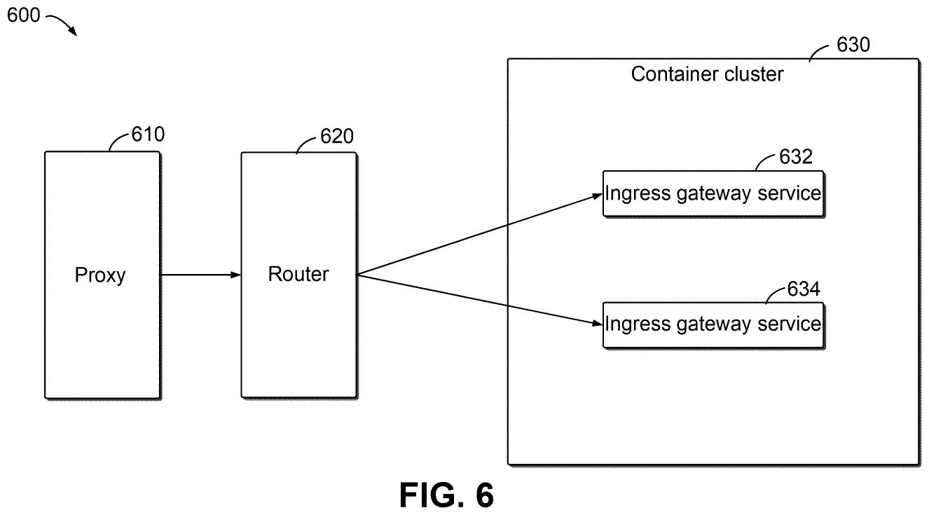

FIG. 6 illustrates a schematic diagram of address translation 600 at a network layer of a multi-level network according to some embodiments of the present disclosure. With reference to FIG. 6, in the multi-level network of the container cluster 630, the bare-metal load balancer is set to the network layer (L3) mode, in which case the ingress gateway service can have multiple addresses. For example, IP A of the ingress gateway service 632 is 10.10.10.30, and IP B of the ingress gateway service 634 is 20.20.20.30. Each of the addresses can be used as a potential address to be accessed by an external proxy 610 (or client).

With continued reference to FIG. 6, the proxy 610 can be configured via a router 620 to be primarily connected to one ingress gateway service. For example, the address IP A of the ingress gateway service 632 can be used as the primary connection address, i.e., 10.10.10.30 can be used as the primary connection address, and the remaining addresses (e.g., the address 20.20.20.30 of an ingress service 734) can be used as the failover addresses in the failure state. If the primary connection address becomes unavailable due to a node failure or any other problem, the proxy 610 can seamlessly switch to 20.20.20.30, which can ensure the stability of the interaction between the container cluster 630 and the external proxy 610. It can be understood that although FIG. 6 does not illustrate the situation where the egress container group and the egress gateway service are on the same node, the two are also configured on the same node. In the present disclosure, only one address is primarily configured as the primary connection, which is different from the case where all addresses in the address pool are open to external proxies.

This effective method of selecting one for configuration can respond to node failures in a timely manner while maintaining the continuity of the service. Moreover, this method can also overcome the limitation that the external proxy has difficulty in effectively tracking the outbound address due to the rapid start and stop of the container.

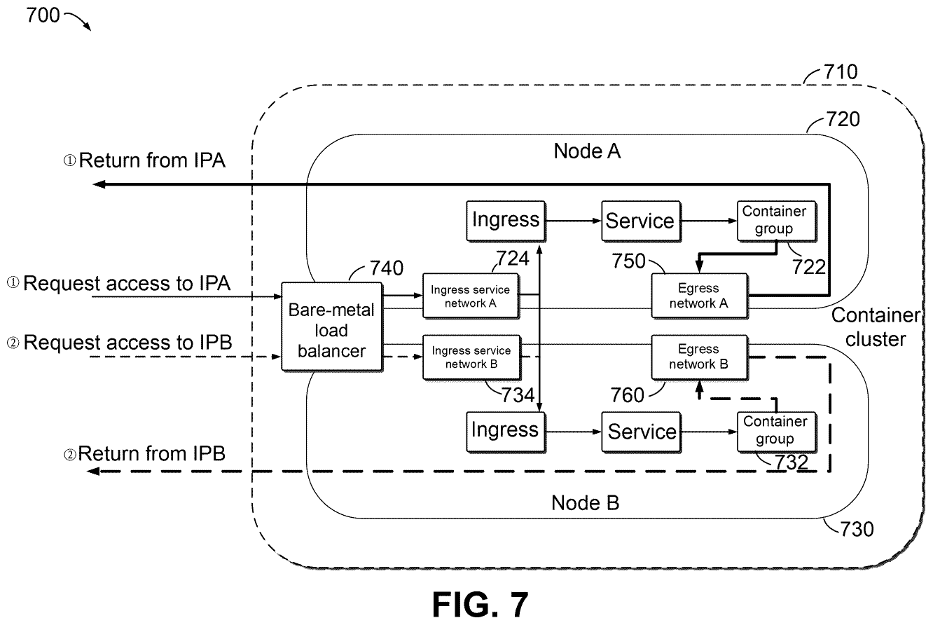

In combination with FIG. 7, the following describes the scheme for address translation in the data link layer mode when an external proxy accesses a container cluster in the case of a multi-level network. FIG. 7 illustrates a schematic diagram of address translation 700 at a data link layer of a multi-level network according to some embodiments of the present disclosure. With reference to FIG. 7, the container cluster 710 is configured in a multi-network environment, which is configured with two levels of networks, i.e., network A and network B, as distinguished by the solid and dashed lines in FIG. 7, where each of the networks is configured with an ingress service, such as an ingress service 724 and an ingress service 734. There are two nodes configured in the container cluster 710, namely, node A 720 and node B 730, each of which has two network interfaces. In this case, the bare-metal load balancer 740 works in the L2 layer mode.

With continued reference to FIG. 7, taking the solid line network A in the figure as an example, when an external proxy or client located in the solid line network shown in FIG. 7 intends to initiate an access request to the container cluster 710, its destination address is the address IP A (e.g., 10.10.10.30) exposed by the ingress service 724, but when the container cluster 710 makes a callback on this external proxy or client, the source address of the data packet it receives may be IP AA (e.g., 10.10.10.10) or IP AB (e.g., 10.10.10.20). Because when the bare-metal load balancer is working in the L2 mode, the source address of the callback data packet of the container cluster 710 will continue to be kept as the private address within the back-end container group (such as the container group 722 or the container group 732, depending on which container group the request is sent to) since the data packet sent out does not need to go through source network address translation. Similarly, when an external proxy or client located in the dashed line network shown in FIG. 7 intends to initiate a request to the container cluster 710, its destination address is the address IP B (e.g., 20.20.20.30) exposed by the ingress service 734, and the source address of the data packet it receives may be IP BA (e.g., 20.20.20.10) or IP BB (e.g., 20.20.20.20).

As can be seen, in this multi-level network and when the bare-metal load balancer is working in the L2 mode, it will become more cumbersome for the external proxy to identify the callback address of the container cluster. To this end, the present disclosure creatively proposes that an egress container group be configured in each network of this multi-level network to cooperate with the ingress service, thereby allowing the source address of the callback to be translated into the network address exposed by the ingress service to the outside.

With continued reference to FIG. 7, in order to unify the destination access address of the external proxy and the source address of the callback of the container cluster in this multi-level network, an egress container group can be configured in each specific network to manage and control the callback traffic from the inside of the network to the outside. For example, for the solid line network A shown in FIG. 7, an egress service 750 may be configured. The egress service 710 here is the egress gateway service corresponding to the ingress gateway, which can be implemented by dispatching the egress container group. As with that of the single-level network, the egress container group here can also be created by a network plugin. Similarly, for the dashed line network B shown in FIG. 7, an egress service 760 can also be configured. In this way, when the container group in the container cluster 710 initiates a callback to the outside, the callback data packet can be forwarded to the external client or proxy via the egress container group or egress network service. The source address seen by the external client or proxy can be translated into the network address exposed to the outside by the egress service or egress gateway in the same network as the egress container group. This can facilitate the verification of communication security by the external proxy, thereby improving the efficiency of communication or interaction and enhancing the user experience.

With continued reference to FIG. 7, for the container cluster 710 in which an egress container group is configured in each network, the routing to each egress service can be configured by setting routing rules. In some embodiments, routing rules can be defined using the network policy of the container cluster or configurations specific to a network plugin. For example, requests for the sub-network 10.10.10.0/24 will be routed to the egress service 750 of the solid line network A, while requests for 20.20.20.0/24 will be routed to the egress service 760 of the dashed line network B. In some embodiments, the configuration of these sub-networks can be performed dynamically, so that changes can be made or new routing rules can be added flexibly at any time according to needs.

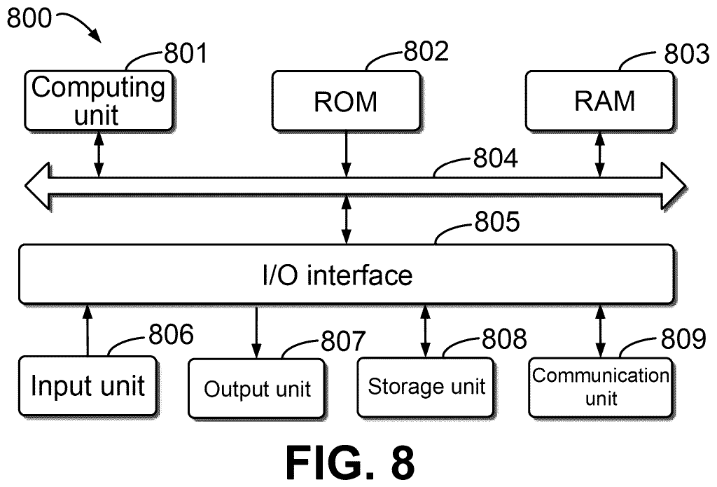

FIG. 8 illustrates a schematic block diagram of an example system 800 that can be used to implement the embodiments of the present disclosure. As shown in the figure, the system 800 includes a computing unit 801 that can perform various appropriate actions and processing according to computer program instructions stored in a read-only memory (ROM) 802 or computer program instructions loaded from a storage unit 808 to a random access memory (RAM) 803. Various programs and data required for the operation of system 800 may also be stored in RAM 803. The computing unit 801, the ROM 802, and the RAM 803 are connected to each other through a bus 804. An input/output (I/O) interface 805 is also connected to the bus 804.

A plurality of components in the system 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the system 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs various methods and processes described above, such as the method 200. For example, in some embodiments, the method 200 may be implemented as a computer software program that is tangibly included in a machine-readable medium, such as the storage unit 808. In some embodiments, part or all of the computer program may be loaded and/or installed onto the system 800 via the ROM 802 and/or the communication unit 809. When the computer program is loaded to the RAM 803 and executed by the computing unit 801, one or more steps of the method 200 described above may be performed. Alternatively, in other embodiments, the computing unit 801 may be configured to implement the method 200 in any other suitable manners (e.g., by means of firmware).

The functions described herein above may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the methods of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for address translation, comprising:
receiving an access request from outside of a cluster service to inside by an ingress control service;
generating a callback for the access request in response to receiving the access request; and
translating a source address of the callback to a network address of the ingress control service by an egress container group, wherein the network address of the ingress control service is a destination address of the access request.

2. The method according to claim 1, wherein translating a source address of the callback to a network address of the ingress control service by an egress container group comprises:
dispatching the egress container group and the ingress control service on the same node in response to a plurality of nodes in the cluster service being in a single-level network, the single-level network denoting a network that is independent and contains no other sub-networks or segments.

3. The method according to claim 2, wherein dispatching the egress container group and the ingress control service on the same node in response to a plurality of nodes in the cluster service being in a single-level network comprises:
forwarding the access request by a border gateway router in response to a load balancer of the cluster service being in a network layer mode, the load balancer being configured to distribute network traffic; and
determining a parameter of the cluster service, the parameter instructing the border gateway router to route the access request to a node of a container group of a service corresponding to running the access request.

4. The method according to claim 3, further comprising:
sending the callback by the egress container group in response to the generation of the callback; and
routing, in response to generation of a response to the callback, the response by the egress container group to a container group running the response.

5. The method according to claim 4, further comprising:
monitoring the same node on which the egress container group and the ingress control service are dispatched; and
re-dispatching, in response to monitoring that the same node is not ready, the egress container group and the ingress control service to another node.

6. The method according to claim 1, wherein translating a source address of the callback to a network address of the ingress control service by an egress container group comprises:
determining the network address of the ingress control service from a plurality of candidate network addresses of the ingress control service in response to a plurality of nodes in the cluster service being in a multi-level network and in response to a load balancer of the cluster service being in a network layer mode; and
translating, in response to the generation of the callback, the source address of the callback to the determined network address of the ingress control service.

7. The method according to claim 6, further comprising:
re-determining the network address of the ingress control service from the plurality of candidate network addresses of the ingress control service in response to an error in the determined network address of the ingress control service.

8. The method according to claim 1, wherein translating a source address of the callback to a network address of the ingress control service by an egress container group comprises:
dispatching the egress container group in each level of network in response to a plurality of nodes in the cluster service being in a multi-level network and in response to a load balancer in the cluster service being in a data link layer mode; and
sending the callback by the egress container group in response to the generation of the callback; and
translating the source address of the callback to the network address of the ingress control service.

9. The method according to claim 8, further comprising:
routing the access request to the egress container group corresponding to each level of the network based on a routing rule for the multi-level network; and
updating the routing rule in response to a change in the multi-level network.

10. The method according to claim 1, further comprising:
dispatching a plurality of the egress container groups on the same node;
monitoring the same node on which the plurality of the egress container groups are dispatched; and
re-dispatching the egress container group in response to a failure of the same node.

11. A system for providing a cluster service, comprising:
at least one processor; and
a memory coupled to the at least one processor and having instructions stored thereon, wherein the instructions, when executed by the at least one processor, cause the system to perform actions comprising:
receiving an access request from outside of a cluster service to inside by an ingress control service;
generating a callback for the access request in response to receiving the access request; and
translating a source address of the callback to a network address of the ingress control service by an egress container group, wherein the network address of the ingress control service is a destination address of the access request.

12. The system according to claim 11, wherein translating a source address of the callback to a network address of the ingress control service by an egress container group comprises:
dispatching the egress container group and the ingress control service on the same node in response to a plurality of nodes in the cluster service being in a single-level network, the single-level network denoting a network that is independent and contains no other sub-networks or segments.

13. The system according to claim 12, wherein dispatching the egress container group and the ingress control service on the same node in response to a plurality of nodes in the cluster service being in a single-level network comprises:
forwarding the access request by a border gateway router in response to a load balancer of the cluster service being in a network layer mode, the load balancer being configured to distribute network traffic; and
determining a parameter of the cluster service, the parameter instructing the border gateway router to route the access request to a node of a container group of a service corresponding to running the access request.

14. The system according to claim 13, wherein the actions further comprise:
sending the callback by the egress container group in response to the generation of the callback; and
routing, in response to generation of a response to the callback, the response by the egress container group to a container group running the response.

15. The system according to claim 14, wherein the actions further comprise:
monitoring the same node on which the egress container group and the ingress control service are dispatched; and
re-dispatching, in response to monitoring that the same node is not ready, the egress container group and the ingress control service to another node.

16. The system according to claim 11, wherein translating a source address of the callback to a network address of the ingress control service by an egress container group comprises:
determining the network address of the ingress control service from a plurality of candidate network addresses of the ingress control service in response to a plurality of nodes in the cluster service being in a multi-level network and in response to a load balancer of the cluster service being in a network layer mode; and
translating, in response to the generation of the callback, the source address of the callback to the determined network address of the ingress control service.

17. The system according to claim 16, wherein the actions further comprise:
re-determining the network address of the ingress control service from the plurality of candidate network addresses of the ingress control service in response to an error in the determined network address of the ingress control service.

18. The system according to claim 11, wherein translating a source address of the callback to a network address of the ingress control service by an egress container group comprises:
dispatching the egress container group in each level of network in response to a plurality of nodes in the cluster service being in a multi-level network and in response to a load balancer in the cluster service being in a data link layer mode; and
sending the callback by the egress container group in response to the generation of the callback; and
translating the source address of the callback to the network address of the ingress control service.

19. The system according to claim 18, wherein the actions further comprise:
routing the access request to the egress container group corresponding to each level of the network based on a routing rule for the multi-level network; and
updating the routing rule in response to a change in the multi-level network.

20. A non-transitory computer-readable medium comprising machine-executable instructions, which when executed by a machine, cause the machine to perform following operations:
receiving an access request from outside of a cluster service to inside by an ingress control service;
generating a callback for the access request in response to receiving the access request; and
translating a source address of the callback to a network address of the ingress control service by an egress container group, wherein the network address of the ingress control service is a destination address of the access request.
